(19) United States
(12) Patent Application Publication
(10) Pub. No.: US 2026/0050945 A1
(43) Pub. Date: Feb. 19, 2026

(54) INTELLIGENT ADVERTISEMENT PLACEMENT SYSTEM USING REINFORCEMENT LEARNING AND QUANTITATIVE MARKET VALUE

(71) Applicant: Kunato Inc., New York, NY (US)

(72) Inventors: Illan POREH, New York, NY (US); MADHUSUDHANAN KRISHNAMOORTHY, Bangalore (IN); CHAIKESH CHOURAGADE, Bangalore (IN)

(21) Appl. No.: 19/299,082

(22) Filed: Aug. 13, 2025

Related U.S. Application Data
(60) Provisional application No. 63/682,367, filed on Aug. 13, 2024.

(51) Int. Cl. G06Q 30/0242; G06Q 30/0201; G06Q 30/0241

(52) U.S. Cl. CPC G06Q 30/0244; G06Q 30/0201; G06Q 30/0277

(57) ABSTRACT

According to an embodiment of the present invention, a method and system to generate recommendation to place a set of digital advertisements is disclosed. The recommendation to place a set of digital advertisements is performed by, receiving a request to place the set of digital advertisements, integrating a digital content valuation as an input to a reinforcement learning agent, assigning a criticality factor for the digital content valuation, employing the reinforcement learning agent to match advertisements with relevant content environments, optimizing the advertisement placement algorithm, generating a recommendation for advertisement placement by the advertisement placement algorithm, wherein generating the recommendation includes matching advertisements with a relevant content environment, placing the advertisement based on the recommendation, and maximizing engagement and revenue generation.

### RELATED APPLICATION DATA

This application claims priority to U.S. Provisional Application No. 63/682,367, filed Aug. 13, 2024, the disclosure of which is hereby incorporated by reference in its entirety.

### FIELD OF TECHNOLOGY

The present invention relates generally to the field of digital advertising, and more specifically to an innovative system and method for generating and placing advertisement content.

### BACKGROUND OF TECHNOLOGY

In today's digital landscape, traditional, static advertisements are losing their effectiveness due to the oversaturation of information. The lack of relation to the digital contents and the advertisements often leads to low engagement rates and a poor user experience. This invention addresses these shortcomings by providing an intelligent placement of advertisement using a reinforcement learning and Quantitative Market Value (QMV).

### SUMMARY OF DESCRIBED SUBJECT MATTER

This invention is a system and method that seamlessly placing advertisements into the digital content. The advertisements are contextually placed based on the content itself and further tailored using a sophisticated Artificial Intelligence (AI) mechanism to reflect the user's preferences and digital content guidelines. It further enhances user engagement by transforming advertisements using feedback mechanisms of the placement of the advertisements.

In an embodiment of the invention, a method and system to generate recommendation to place a set of digital advertisements is disclosed. The recommendation to place a set of digital advertisements is performed by receiving a request to place the set of digital advertisements, integrating a digital content valuation as an input to a reinforcement learning agent, assigning a criticality factor for the digital content valuation, employing the reinforcement learning agent to match advertisements with relevant content environments, optimizing the advertisement placement algorithm, generating a recommendation for advertisement placement by the advertisement placement algorithm, wherein generating the recommendation includes matching advertisements with a relevant content environment, placing the advertisement based on the recommendation, and maximizing engagement and revenue generation.

In another embodiment of the invention, the advertisement placement algorithm includes an allocation policy, wherein an action is performed based on the allocation policy.

In another embodiment of the invention, the processor is further configured to use the offline data of the advertisement to place the advertisement.

In another embodiment of the invention, the advertisement placement algorithm includes an advertisement campaign.

In another embodiment of the invention, the offline data of the advertisement is used to generate advertisement campaign statistics.

In another embodiment of the invention, the matching advertisements with a relevant content environment includes a q-learning matching policy, wherein the q-learning matching policy perform the matching advertisements with a relevant content environment.

In another embodiment of the invention, the advertisement campaign further comprises, receiving a set of bid distribution data, receiving a bid value and remaining budget from an agent, and utilizing the set of bid distribution data, the bid value and the remaining budget from the agent, by the advertisement placement algorithm.

The present invention will now be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices or a combination thereof. Accordingly, the present invention may take the form of an entirely hardware embodiment, an entirely software embodiment, or an embodiment combining software and hardware aspects. The following detailed description is, therefore, not to be taken in a limiting sense.

The proposed system presents an innovative approach to optimize advertisement placement through the integration of Quantitative Market Value (QMV) assessment and reinforcement learning techniques. By leveraging QMV as a critical decision factor, the system employs a reinforcement learning agent to match advertisements with relevant content environments effectively. Through continuous learning and adaptation, the agent identifies optimal ad placements to maximize engagement and revenue generation, thereby enhancing the efficiency and effectiveness of advertising strategies.

### BRIEF DESCRIPTION OF THE DRAWINGS

Various embodiments of the present disclosure can be further explained with reference to the attached drawings, wherein like structures are referred to by like numerals throughout the several views. The drawings shown are not necessarily to scale, with emphasis instead generally being placed upon illustrating the principles of the present disclosure. Therefore, specific structural and functional details disclosed herein are not to be interpreted as limiting, but merely as a representative basis for teaching one skilled in the art to variously employ one or more illustrative embodiments.

FIG. 1 illustrates a schematic view of the system in accordance with exemplary embodiments of the disclosed subject matter.

FIG. 2 illustrates a schematic view of a component of the system in accordance with exemplary embodiments of the disclosed subject matter.

FIG. 3 illustrates a architecture view of a system in accordance with exemplary embodiments of the disclosed subject matter.

FIGS. 4A-4B illustrate components of a system in accordance with exemplary embodiments of the disclosed subject matter.

FIG. 5 illustrates a flowchart in accordance with exemplary embodiments of the disclosed subject matter.

FIG. 6 illustrates a Q Learning-Matching Policy in accordance with exemplary embodiments of the disclosed subject matter.

While the present disclosure will be described in connection with the preferred embodiments shown herein, it will be understood that it is not intended to limit the invention to those embodiments. On the contrary, it is intended to cover all alternatives, modifications, and equivalents, as may be included within the spirit and scope of the invention as defined by the appended claims.

### DETAILED DESCRIPTION

Various detailed embodiments of the present disclosure, taken in conjunction with the accompanying figures, are disclosed herein; however, it is to be understood that the disclosed embodiments are merely illustrative. In addition, each of the examples given in connection with the various embodiments of the present disclosure is intended to be illustrative, and not restrictive.

Throughout the specification, the following terms take the meanings explicitly associated herein, unless the context clearly dictates otherwise. The phrases “in one embodiment” and “in some embodiments” as used herein do not necessarily refer to the same embodiment(s), though it may. Furthermore, the phrases “in another embodiment” and “in some other embodiments” as used herein do not necessarily refer to a different embodiment, although it may. Thus, as described below, various embodiments may be readily combined, without departing from the scope or spirit of the present disclosure.

The terms “include,” “have,” and variations thereof, as used herein, have the same meaning as the term “comprise” or appropriate variation thereof. Furthermore, the term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the terms “and” and “or” may be used interchangeably to refer to a set of items in both the conjunctive and disjunctive in order to encompass the full description of combinations and alternatives of the items. By way of example, a set of items may be listed with the disjunctive “or”, or with the conjunction “and.” In either case, the set is to be interpreted as meaning each of the items singularly as alternatives, as well as any combination of the listed items.

The inventors are also aware of the normal precepts of English grammar. Thus, if a noun, term, or phrase is intended to be further characterized, specified, or narrowed in some way, such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

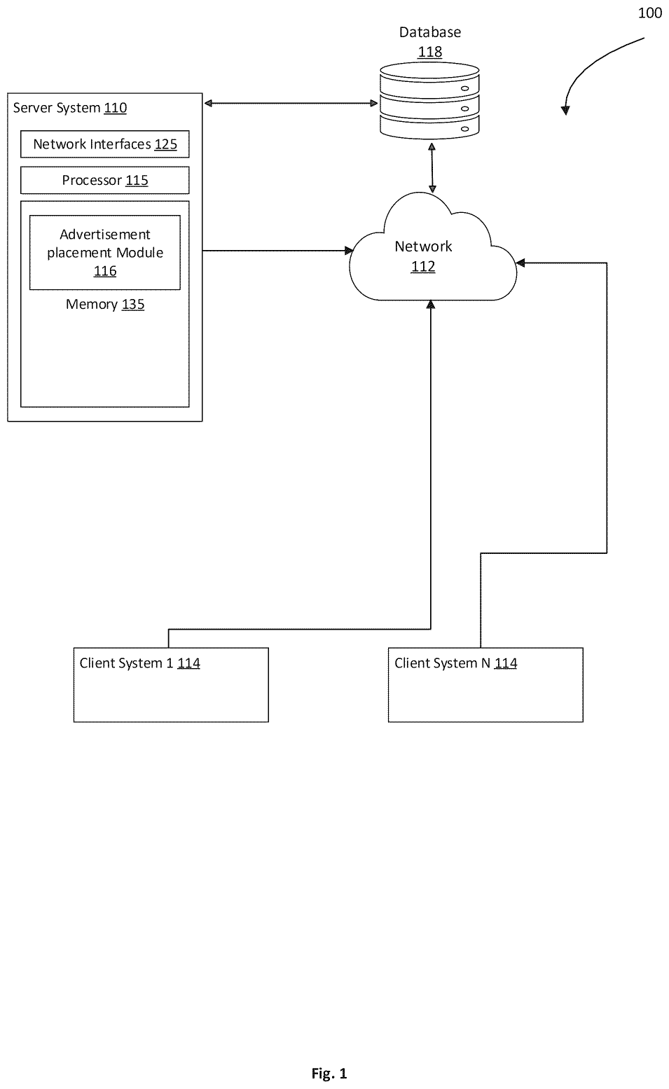

FIGS. 1 through 6 illustrate systems and methods to generate a placement of a set of digital advertisements for digital content. The disclosed subject matter enhances advertising efficacy by leveraging quantitative market value and reinforcement learning (RL) algorithms for dynamic ad placement optimization. The following embodiments provide technical solutions and technical improvements that overcome technical problems, drawbacks and/or deficiencies in the technical fields involving static valuation and placement of advertisement that provide an obstacle to interoperability between multiple sources of data, thus preventing dynamic valuation and placement of the advertisements. Such conventional systems fall short in precision, leading to inefficient impression utilization and diminished returns on investment. As explained in more detail, below, technical solutions and technical improvements herein include the integration of the digital content valuation, use of multi-source valuation attributes, and embedding similarity as part of the RL policy input. Such integration of quantitative market value metrics with advanced reinforcement learning techniques enables real-time adjustment and optimization of advertisement placements, ensuring optimal audience targeting and maximizing advertising impact.

Multi-source valuation attributes (e.g., revenue, criticality, market indicators) compute both reward and placement optimization, creating a closed-loop feedback system. Embedding similarity is not just a matching layer, but part of the RL policy input, allowing contextual reinforcement to evolve over time. The RL agent is directly conditioned on valuation-driven utility, giving it the ability to differentiate between high-performing but low-value content and moderate-performing but strategically critical content, a use of multi-objective reward modeling. Based on such technical features, further technical benefits become available to users and operators of these systems and methods. Moreover, various practical applications of the disclosed technology are also described, which provide further practical benefits to users and operators that are also new and useful improvements in the art.

The disclosed subject matter introduces an advanced AI module or a set of AI modules by incorporating AI into the placement of advertisements providing benefits in terms of scalability, efficiency, and personalization. It allows for the placement of a large number of unique, tailored advertisements in real-time, matching the digital content. Furthermore, the AI module can learn from user engagement data to continuously improve the placement of the advertisements.

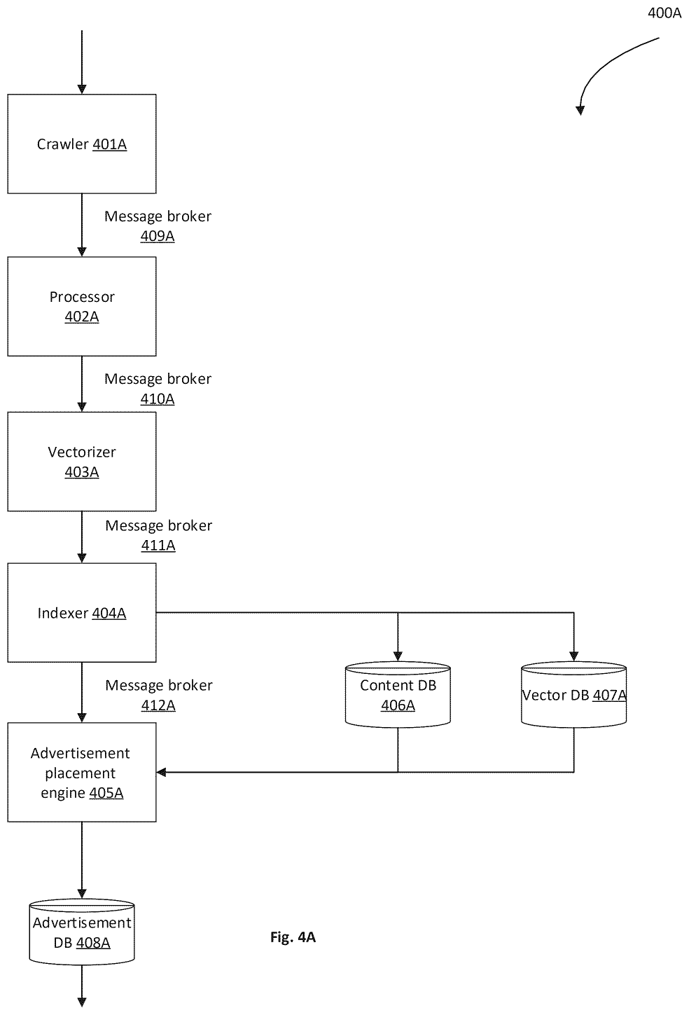

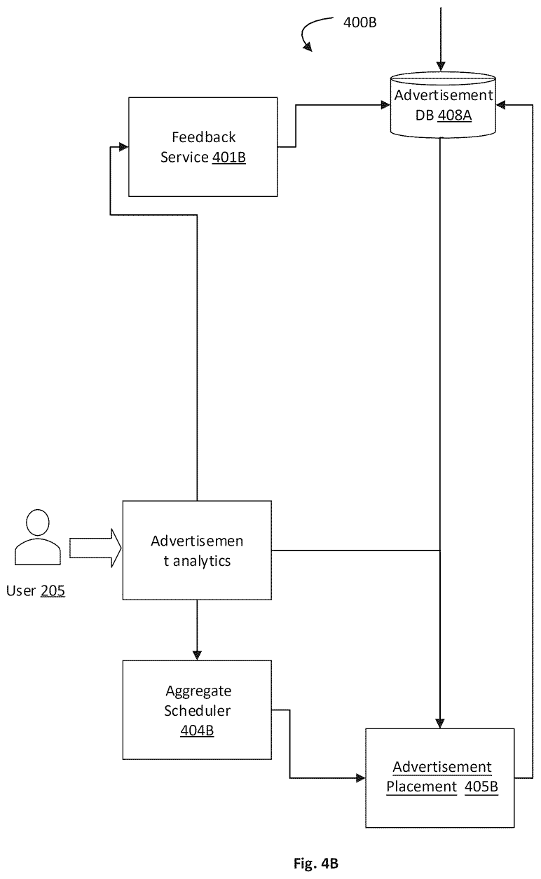

The subject matter disclosed herein is a platform for intelligent ad allocation. The system ingests content via crawlers 401A (FIG. 4A), assigns valuations and vectors to digital content through vector DB 407A, trains a reinforcement learning model (agent), generates ad placement recommendations in real time, tracks feedback (FIG. 4B) to refine and improve future decisions. When compared with conventional methods, such as, e.g., Google Ads, Meta Ads, that use heuristics or auction-based ranking with predefined metrics (CTR, bids, impressions), the novel RL-based approach described herein integrates dynamic, environment-aware learning, incorporates criticality of content, learns optimal placement not just for cost-efficiency but also for content match, timing, and revenue uplift, uses a closed-loop system with feedback-driven reoptimization (see FIG. 4B), and uses the pricing of the content to assess the exact market value in order to match the advertisement.

A person of ordinary skill in the art will appreciate that embodiments and exemplary scenarios of the disclosed subject matter may be practiced with various computer system configurations, including multi-core multiprocessor systems, minicomputers, mainframe computers, computers linked or clustered with distributed functions, as well as pervasive or miniature computers that may be embedded into virtually any device. Further, the operations may be described as a sequential process; however some of the operations may in fact be performed in parallel, concurrently, and/or in a distributed environment, and with program code stored locally or remotely for access by single or multiprocessor machines. In addition, in some embodiments, the order of operations may be rearranged without departing from the spirit of the disclosed subject matter.

Techniques consistent with the disclosure provide, among other features, an Internet advertisement engine that is integrated with various features, tools, or components for enabling a user to perform an easy, enhanced, reliable, and quality generation of advertisements. While various exemplary embodiments of the disclosed systems have been described above, it should be understood that they have been presented for purposes of example only, and not limitations. It is not exhaustive and does not limit the disclosure to the precise form disclosed. Modifications and variations are possible in light of the above teachings or may be acquired from practicing of the disclosure, without departing from the breadth or scope.

In some embodiments, referring to FIG. 1, platform 100 includes a server system 110 and a database 118. One or more client devices, e.g., client device 1 114 through client device N 114, sometimes referred to collectively as client device(s) 114 are connected to the server system 110 via network 112. Client device(s) 114 of the exemplary computer-based system and platform 100 may include virtually any computing device capable of receiving and sending a message over a network (e.g., cloud network), such as network 112, to and from another computing device, such as server system 110, each other, and the like. In some embodiments, the client device(s) 114 may be personal computers, multiprocessor systems, microprocessor-based or programmable consumer electronics, network PCs, and the like. In some embodiments, one or more client device(s) 114 may include computing devices that typically connect using a wireless communications medium such as cell phones, smart phones, pagers, walkie talkies, radio frequency (RF) devices, infrared (IR) devices, citizens band radio, integrated devices combining one or more of the preceding devices, or virtually any mobile computing device, and the like. In some embodiments, one or more client device(s) 114 may be devices that are capable of connecting using a wired or wireless communication medium such as a PDA, POCKET PC, wearable computer, a laptop, tablet, desktop computer, a netbook, a video game device, a pager, a smart phone, an ultra-mobile personal computer (UMPC), and/or any other device that is equipped to communicate over a wired and/or wireless communication medium (e.g., NFC, RFID, NBIOT, 3G, 4G, 5G, GSM, GPRS, WiFi, WiMax, CDMA, OFDM, OFDMA, LTE, satellite, ZigBee, etc.). In some embodiments, one or more client device(s) 114 may include may run one or more applications, such as Internet browsers, mobile applications, voice calls, video games, videoconferencing, and email, among others. In some embodiments, one or more client device(s) 114 may be configured to receive and to send web pages, and the like. In some embodiments, an exemplary specifically programmed browser application of the present disclosure may be configured to receive and display graphics, text, multimedia, and the like, employing virtually any web based language, including, but not limited to Standard Generalized Markup Language (SMGL), such as HyperText Markup Language (HTML), a wireless application protocol (WAP), a Handheld Device Markup Language (HDML), such as Wireless Markup Language (WML), WMLScript, XML, JavaScript, and the like. In some embodiments, a client device(s) 114 may be specifically programmed by either Java, .Net, QT, C, C++, Python, PHP and/or other suitable programming language. In some embodiment of the device software, device control may be distributed between multiple standalone applications. In some embodiments, software components/applications can be updated and redeployed remotely as individual units or as a full software suite. In some embodiments, a member device may periodically report status or send alerts over text or email. In some embodiments, a member device may contain a data recorder which is remotely downloadable by the user using network protocols such as FTP, SSH, or other file transfer mechanisms. In some embodiments, a member device may provide several levels of user interface, for example, advance user, standard user. In some embodiments, one or more client device(s) 114 may be specifically programmed include or execute an application to perform a variety of possible tasks, such as, without limitation, messaging functionality, browsing, searching, playing, streaming or displaying various forms of content, including locally stored or uploaded messages, images and/or video, and/or games.

In some embodiments, exemplary network 112 may provide network access, data transport and/or other services to any computing device coupled to it. In some embodiments, the exemplary network 112 may include and implement at least one specialized network architecture that may be based at least in part on one or more standards set by, for example, without limitation, Global System for Mobile communication (GSM) Association, the Internet Engineering Task Force (IETF), and the Worldwide Interoperability for Microwave Access (WiMAX) forum. In some embodiments, the exemplary network 112 may implement one or more of a GSM architecture, a General Packet Radio Service (GPRS) architecture, a Universal Mobile Telecommunications System (UMTS) architecture, and an evolution of UMTS referred to as Long Term Evolution (LTE). In some embodiments, the exemplary network 112 may include and implement, as an alternative or in conjunction with one or more of the above, a WiMAX architecture defined by the WiMAX forum. In some embodiments and, optionally, in combination of any embodiment described above or below, the exemplary network 112 may also include, for instance, at least one of a local area network (LAN), a wide area network (WAN), the Internet, a virtual LAN (VLAN), an enterprise LAN, a layer 3 virtual private network (VPN), an enterprise IP network, or any combination thereof. In some embodiments and, optionally, in combination of any embodiment described above or below, at least one computer network communication over the exemplary network 112 may be transmitted based at least in part on one of more communication modes such as but not limited to: NFC, RFID, Narrow Band Internet of Things (NBIOT), ZigBee, 3G, 4G, 5G, GSM, GPRS, WiFi, WiMax, CDMA, OFDM, OFDMA, LTE, satellite and any combination thereof. In some embodiments, the exemplary network 112 may also include mass storage, such as network attached storage (NAS), a storage area network (SAN), a content delivery network (CDN) or other forms of computer or machine readable media.

In some embodiments, the server system 110 may include a web server (or a series of servers) running a network operating system, examples of which may include but are not limited to Apache on Linux or Microsoft IIS (Internet Information Services). In some embodiments, the server system 110 may be used for and/or provide cloud and/or network computing. Although not shown in FIG. 1, some embodiments, the exemplary network 112 may have connections to external systems like email, SMS messaging, text messaging, ad content providers, etc.

In some embodiments, one or more of the exemplary network 112 may be specifically programmed to perform, in non-limiting example, as authentication servers, search servers, email servers, social networking services servers, Short Message Service (SMS) servers, Instant Messaging (IM) servers, Multimedia Messaging Service (MMS) servers, exchange servers, photo-sharing services servers, advertisement providing servers, financial/banking-related services servers, travel services servers, or any similarly suitable service-base servers for users of the server system 110 and client devices 114.

In some embodiments and, optionally, in combination of any embodiment described above or below, for example, one or more client devices 114 and the server system 110 may include a specifically programmed software module that may be configured to send, process, and receive information using a scripting language, a remote procedure call, an email, a tweet, Short Message Service (SMS), Multimedia Message Service (MMS), instant messaging (IM), an application programming interface, Simple Object Access Protocol (SOAP) methods, Common Object Request Broker Architecture (CORBA), HTTP (Hypertext Transfer Protocol), REST (Representational State Transfer), SOAP (Simple Object Transfer Protocol), MLLP (Minimum Lower Layer Protocol), or any combination thereof.

FIG. 1 further depicts a block diagram of the server system 110 in accordance with one or more embodiments of the present disclosure. In some embodiments, the server system 110 includes a computer-readable medium 135, such as a random-access memory (RAM) coupled to a processor 115 or FLASH memory. In some embodiments, the processor 115 may execute computer-executable program instructions stored in memory 135. In some embodiments, the processor 115 may include a microprocessor, an ASIC, and/or a state machine. In some embodiments, the processor 115 may include, or may be in communication with, media, for example computer-readable media, which stores instructions that, when executed by the processor 115, may cause the processor 115 to perform one or more steps described herein. In some embodiments, examples of computer-readable media may include, but are not limited to, an electronic, optical, magnetic, or other storage or transmission device capable of providing a processor, such as the processor of client device 114, with computer-readable instructions. In some embodiments, other examples of suitable media may include, but are not limited to, a floppy disk, CD-ROM, DVD, magnetic disk, memory chip, ROM, RAM, an ASIC, a configured processor, all optical media, all magnetic tape or other magnetic media, or any other medium from which a computer processor can read instructions. Also, various other forms of computer-readable media may transmit or carry instructions to a computer, including a router, private or public network, or other transmission device or channel, both wired and wireless. In some embodiments, the instructions may comprise code from any computer-programming language, including, for example, C, C++, Visual Basic, Java, Python, Perl, JavaScript, and etc. The server system 110 further includes a network interface 125 by any wired or wireless protocols known in the art.

In some embodiments, client devices 114 may also comprise a number of external or internal devices such as a mouse, a CD-ROM, DVD, a physical or virtual keyboard, a display, or other input or output devices. In some embodiments, examples of client devices 114 may be any type of processor-based platforms that are connected to a network 112 such as, without limitation, personal computers, digital assistants, personal digital assistants, smart phones, pagers, digital tablets, laptop computers, Internet appliances, and other processor-based devices. In some embodiments, client devices 114 may be specifically programmed with one or more application programs in accordance with one or more principles/methodologies detailed herein. In some embodiments, client devices 114 may operate on any operating system capable of supporting a browser or browser-enabled application, such as Microsoft™, Windows™, and/or Linux. In some embodiments, client devices 114 may include, for example, personal computers executing a browser application program such as Microsoft Corporation's Internet Explorer™, Apple Computer, Inc.'s Safari™, Mozilla Firefox, and/or Opera. In some embodiments, client devices 114 may communicate over the exemplary network 112 with each other and/or with other systems and/or devices coupled to the network. Client devices 114 may include a processor as well as memory, not shown. In some embodiments, the system server 110 and the one or more client devices 114 may be mobile devices. As used herein, the term “mobile electronic device,” or the like, may refer to any portable electronic device that may or may not be enabled with location tracking functionality (e.g., MAC address, Internet Protocol (IP) address, or the like). For example, a mobile electronic device can include, but is not limited to, a mobile phone, Personal Digital Assistant (PDA), Blackberry™, Pager, Smartphone, or any other reasonable mobile electronic device.

In some embodiments, advertisement placement critically includes geographical information to maximize value. Accordingly, terms “proximity detection,” “locating,” “location data,” “location information,” and “location tracking” refer to any form of location tracking technology or locating method that can be used to provide a location of, for example, a particular computing device, system or platform of the present disclosure and any associated computing devices, based at least in part on one or more of the following techniques and devices, without limitation: accelerometer(s), gyroscope(s), Global Positioning Systems (GPS); GPS accessed using Bluetooth™; GPS accessed using any reasonable form of wireless and non-wireless communication; WiFi™ server location data; Bluetooth™ based location data; triangulation such as, but not limited to, network based triangulation, WiFi™ server information based triangulation, Bluetooth™ server information based triangulation; Cell Identification based triangulation, Enhanced Cell Identification based triangulation, Uplink-Time difference of arrival (U-TDOA) based triangulation, Time of arrival (TOA) based triangulation, Angle of arrival (AOA) based triangulation; techniques and systems using a geographic coordinate system such as, but not limited to, longitudinal and latitudinal based, geodesic height based, Cartesian coordinates based; Radio Frequency Identification such as, but not limited to, Long range RFID, Short range RFID; using any form of RFID tag such as, but not limited to active RFID tags, passive RFID tags, battery assisted passive RFID tags; or any other reasonable way to determine location. For ease, at times the above variations are not listed or are only partially listed; this is in no way meant to be a limitation.

In some embodiments, at least one database 118 of exemplary databases may be any type of database, including a database managed by a database management system (DBMS). In some embodiments, an exemplary DBMS-managed database may be specifically programmed as an engine that controls organization, storage, management, and/or retrieval of data in the respective database. In some embodiments, the exemplary DBMS-managed database may be specifically programmed to provide the ability to query, backup and replicate, enforce rules, provide security, compute, perform change and access logging, and/or automate optimization. In some embodiments, the exemplary DBMS-managed database may be chosen from Oracle database, IBM DB2, Adaptive Server Enterprise, FileMaker, Microsoft Access, Microsoft SQL Server, MySQL, PostgreSQL, and a NoSQL implementation. In some embodiments, the exemplary DBMS-managed database may be specifically programmed to define each respective schema of each database in the exemplary DBMS, according to a particular database model of the present disclosure which may include a hierarchical model, network model, relational model, object model, or some other suitable organization that may result in one or more applicable data structures that may include fields, records, files, and/or objects. In some embodiments, the exemplary DBMS-managed database may be specifically programmed to include metadata about the data that is stored.

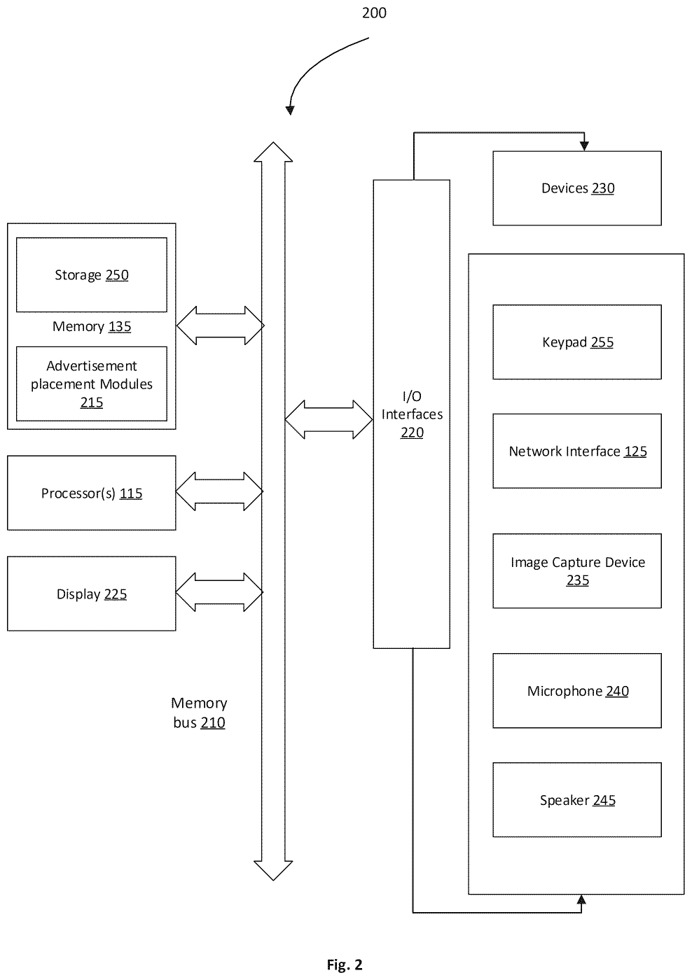

FIG. 2 is a further schematic view of the device 200, that can include system server 110 or client device 114 as discussed above. Each exemplary device 200 includes a processor 114, memory 135 and display 225. The memory 135, as discussed above, includes storage 250 and an advertisement placement module 215. Device 200 further includes I/O interfaces 220 for connecting devices 230, keypad 225, network interface 125, image capture device 235, microphone 240 and speaker 245 to the processor 115, memory 135 and display 225 via a memory bus 210.

In some embodiments, the exemplary inventive computer-based systems/platforms, the exemplary inventive computer-based devices, and/or the exemplary inventive computer-based components of the present disclosure may be specifically configured to operate in a cloud computing/architecture such as, but not limiting to: infrastructure a service (IaaS) 910, platform as a service (PaaS), and/or software as a service (SaaS) using a web browser, mobile app, thin client, terminal emulator or other endpoint.

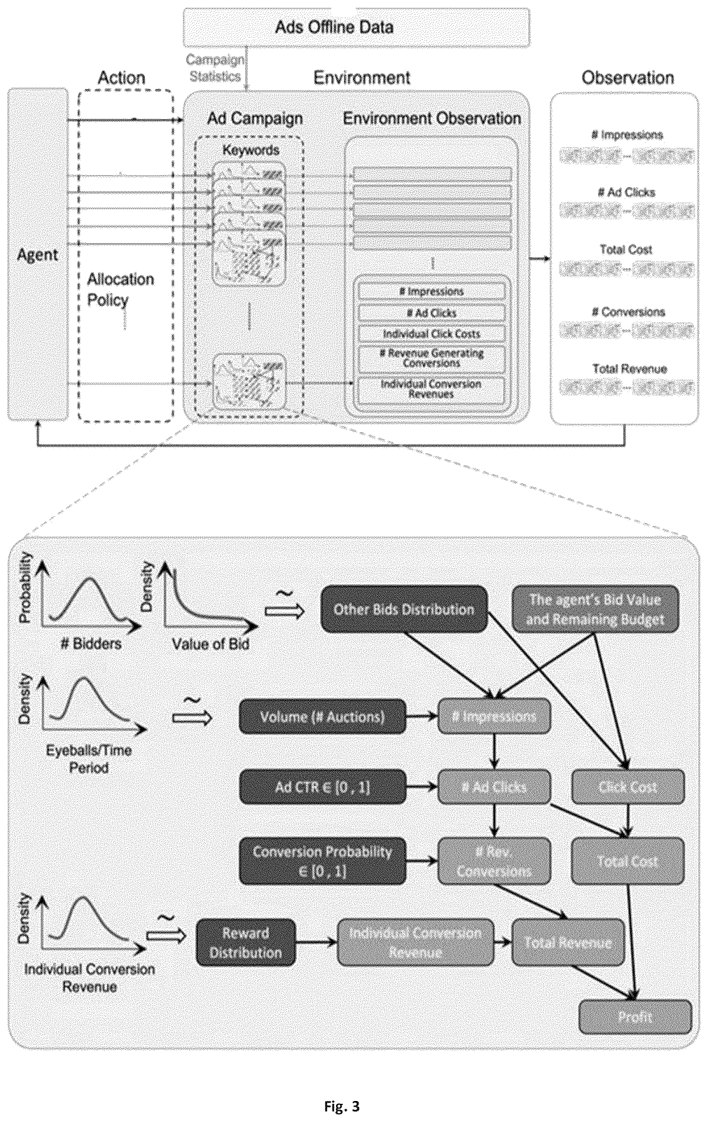

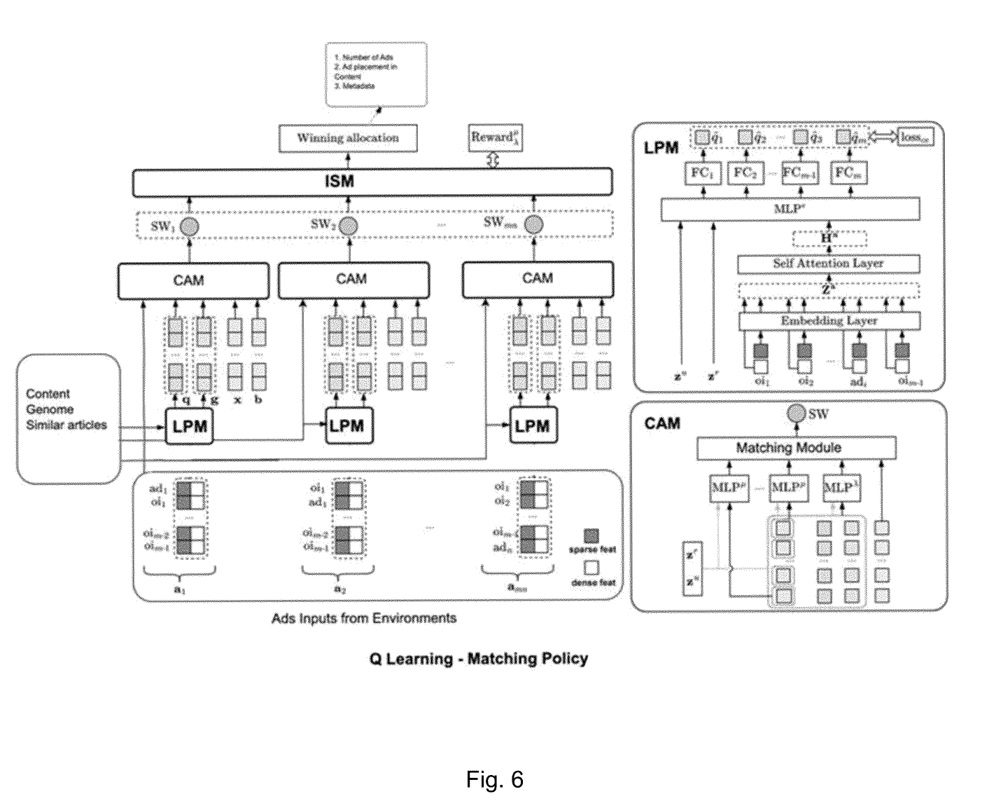

FIG. 3 illustrates the architecture of the system described herein illustrating the agent, action space, environment space and observation space as understood in the art. The action space, which is the set of all possible actions that the agent can take in the environment. The action space includes the allocation policy as further illustrated in FIG. 6. In exemplary embodiments, the action space selects ads for a given content slot, sets bid value and allocates remaining budget. The environment space, i.e., state space, is the set of all possible states that the environment can be in. The environment space refers to the entire context or system where the agent interacts, including its rules and state transitions. Thus, the environment space defines the dynamics of the environment, such as how the state changes when an agent takes an action. The environment also provides a reward function to guide the agent's learning. The observation space is the set of all possible observations that the agent can perceive from the environment. In partially observable environments, the agent may only have access to a subset of the full state, and the observation space reflects what the agent can actually observe. The environment space is a full description of the environment. The observation space is what the agent can observe or perceive. In the exemplary embodiments, the observation space can include number of impressions, number of ad clicks, total cost of ads, number of conversions (please elaborate) and the total revenue generated the ads.

The lower panel in FIG. 3 further illustrates the reward function as incorporated herein with the RL agent, which is designed to model the long-term campaign value. The reward function is computed from such parameters such as engagement metrics (clicks, dwell time, scroll depth, share activity); revenue metrics (conversion rate, effective Cost per thousand impressions (CPM), Cost per Action (CPA)); and penalty components, such as content mismatch (e.g., user bounces within 1 sec), demographic deviation (e.g., ad seen by wrong age/gender cohort), and reputation risk (e.g., ad appears next to polarizing content). The RL agent maximizes the discounted sum of reward over user session, not just per impression, which provides long-term optimization.

FIGS. 4A-4B illustrates exemplary components 400A/400B of the system server 110 as described herein. Each of the components may be distributed. In some embodiments, exemplary inventive, the specially programmed server system 110 and platform 100 with associated devices are configured to operate in the distributed network environment, communicating with one another over one or more suitable data communication networks (e.g., the Internet, satellite, etc.) and utilizing one or more suitable data communication protocols/modes such as, without limitation, IPX/SPX, X.25, AX.25, AppleTalk(™), TCP/IP (e.g., HTTP), near-field wireless communication (NFC), RFID, Narrow Band Internet of Things (NBIOT), 3G, 4G, 5G, GSM, GPRS, WiFi, WiMax, CDMA, satellite, ZigBee, and other suitable communication modes.

As illustrated in FIG. 4A, crawler 401A gathers data from the web for training the RL agent. The crawled data is provided to the processor 402A via the message broker 410A that facilitates communication between different components of the RL agent. A vectorizer 403A receives data processed by the processor 402 via message broker 410A and vectorizes the crawled content into embeddings stored in Vector Database 407A. An indexer 404A receives data processed by the vectorizer 403A via message broker 411A. Advertisement placement agent 405A determines the advertisement placement data based on Content DB 406A, the Vector DB 407A and indexed data via message broker 412A. Advertisement placement data is stored in Advertisement DB 408A. With reference to FIG. 4B, the advertisement placement module 405B controls the placement of the advertisement. Advertisement analytics module 409 receives user input from user(s) 205, such as click-through rates (CTR), including, e.g., ages of users, gender, regional response (urban vs. rural), etc. The feedback service 401B provides updated information to the Advertisement DB 408A, the aggregate scheduler 404B provides updated information to the advertisement placement module 405B.

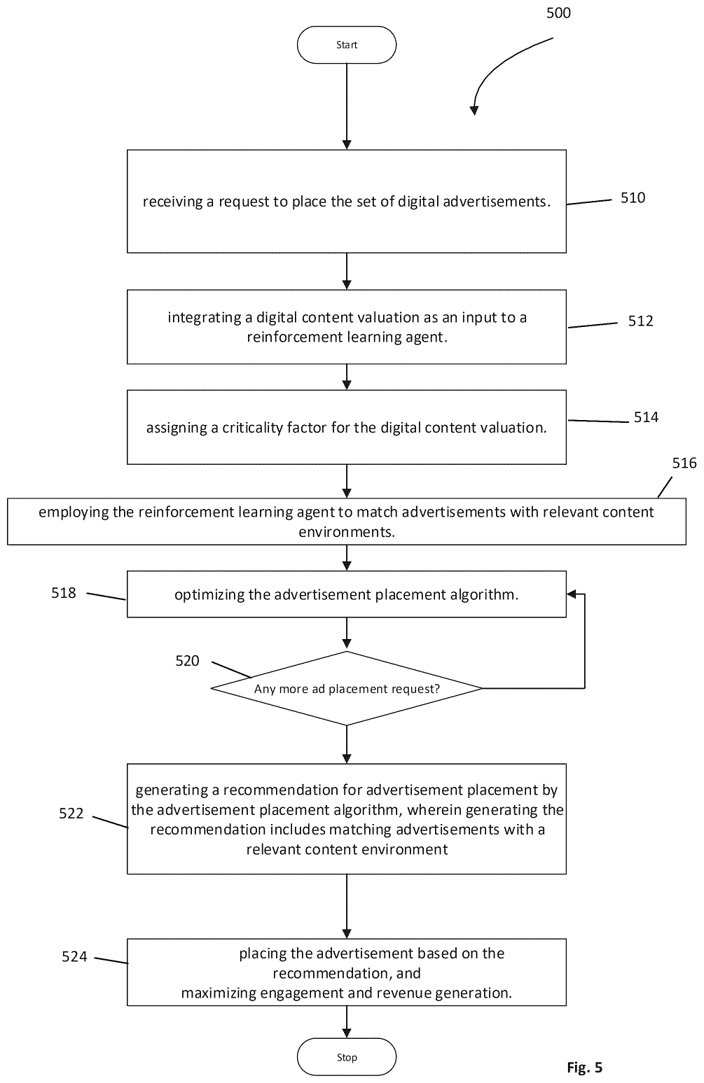

FIG. 5 illustrates an exemplary operational flow of advertisement placement. Generally, crawled content is processed and vectorized into embeddings (See FIG. 4A, vectorizer 404, stored in Vector DB 407A). The valuation of content is computed via LPM, taking into consideration such parameters as content performance, audience behaviour, similar articles, and external market indicators. These valuations are passed as input features to the RL agent (See, FIG. 5, steps 512 and 514). These become part of the state in the RL formulation:

state=[content_embedding, valuation_score (LPM), criticality_factor, past ad engagement]

action=[ad slot allocation, bid value, placement decision]

This allows the agent to differentiate between high- and low-value placements, influencing reward prediction.

With continued reference to FIG. 5, step 510 includes receiving a request from the processor to place a set of digital advertisements, in response to user's request to place such. At step 512, the LPM processor(s) integrate a digital content valuation which serves as an input to the RL agent, discussed in greater detail below. Integration includes vectorizing crawled digital content and digital content related to the digital content into embeddings. A valuation of the digital content is determined, which includes the value of the digital content, a revenue expectation, a criticality weighting and a market adjusted bid value. The determination considers historical performance of the digital content, user/audience behavior regarding the digital content, the pricing of similar digital content and external market indicators. Examples of external market indicators include search engine trend velocity, e.g., Google Trends score over the past 72 hours for the content's topic; a social virality index, e.g., share ratio, retweet counts, and acceleration rate on platforms such as X, LinkedIn, Reddit; ad bidding trends, e.g., average bid per thousand impressions (CPM) for similar content in the last 24 hours; SEO competitive scores, e.g., MOZ/Page Rank value to determine organic competition; and content freshness coefficient, e.g., inverse of time since last similar content posted on major publishers.

At step 512, a criticality factor is assigned to the digital content valuation. The criticality factor is a scalar score computed from a weighted sum of normalized metrics, such as one or more of newsworthiness, timeliness, market competition level, demographics, macroeconomic factors, and strategic priorities. Newsworthiness is computed, e.g., using a Named Entity Recognition (NER) model, and a breaking-news classifier trained on headline urgency. Timeliness represents how closely the content aligns with trending time windows (e.g., peak vs. off-peak). Market competition level represents the number of ad campaigns targeting the same semantic cluster within a given slot. A “slot” refers to a discrete ad opportunity, defined by a combination of time (e.g., morning, prime time, hourly window), placement location (e.g., top banner on a news homepage, mid-article ad unit, mobile push notification), contextual category (e.g., sports, politics, entertainment) and audience segment (e.g., region, demographic cohort). An example, a slot is a “Top Story Banner @ 9 am on Sports Homepage.” Demographics include age-weighted click-through rate (CTR), gender engagement bias, and regional response skew (e.g., urban vs. rural). Macroeconomic factors include Purchasing Power Index of target region, interest rate fluctuations impacting ad spend. Strategic priorities include political neutrality scores and brand safety category (e.g., GARM taxonomy compliance). In some embodiments, the criticality factor directly influences bid amplification and ad placement amplification.

At step 516, the RL agent uses inputs of the valuation and criticality factor and matches advertisement with relevant content environments. As discussed herein, the RL agent is designed to model the long-term campaign value. The reward function is computed from such parameters such as engagement metrics (clicks, dwell time, scroll depth, share activity); revenue metrics (conversion rate, effective cost per thousand impressions (CPM), cost per action (CPA)); and penalty components, such as content mismatch (e.g., user bounces within 1 sec), demographic deviation (e.g., ad seen by wrong age/gender cohort), and reputation risk (e.g., ad appears next to polarizing content). The RL agent maximizes the discounted sum of reward over user session, not just per impression, which provides long-term optimization.

At step 518, optimizing the advertisement placement algorithm is performed. The agent is trained on offline ad data (See, e.g., FIG. 3) to learn cost-efficient and conversion maximizing policies. It simulates auctions, click costs etc.

At step 520, a determination is made concerning whether any additional ad placement is required. If additional ad placement is required, the flow returns to step 518 for additional optimization. If no additional ad placement is required, the algorithm proceeds to step 522, which is generating a recommendation for advertisement placement by the advertisement placement algorithm, wherein generating a recommendation includes producing a strategic mapping between advertisement content, valuation and criticality of the hosting digital content and expected engagement and revenue metrics. During the generating step 522, the RL agent selects advertisements based on content embedding, valuation and budget and produces a recommendation, which is an instruction of which ad to place, where to place and when to place. The RL agent is directly conditioned on valuation driven utility, providing it the ability to differentiate between high-performing but low-value content and moderate-performing but strategically critical content.

Matching content at step 516 includes employing the RL agent to march ads to content. In some embodiments, this step refers to candidate scoring, e.g., identifying which ads are semantically and contextually suitable for a given piece of content based on embedding similarity and value alignment. Step 520 involves ranking and filtering the scored candidates based on business constraints, e.g., budget, frequency caps, targeting rules and finalizing the recommended advertisement-content pair.

Step 524 is placing the advertisement based on the recommendation and maximizing engagement and revenue generation. The placement of advertisement is performed using the placement engine 405A/B as provided by the recommendation, through message broker flow. The flow continues with real-time feedback (See, FIG. 4B, feedback service 401B) and reoptimization, improving the reward function over time. This maximizes engagement cumulatively over campaigns.

FIG. 6 illustrates the Q Learning-Matching Policy. The flow of the process to match advertisements with relevant content environments begins with environment inputs, such as bid distributions, budgets, impressions, click-through and conversion probabilities (also shown in the lower panel of FIG. 3). The action space selects ads for a given content slot, sets bid value and allocates the remaining budget. The architecture illustrates the Large Pricing Model (LPM) performs content valuation. The LPM assigns a monetary value to the advertisement-content match by computing content valuation, revenue expectation, criticality weight, and market adjusted bid value. The Content Attention Module (CAM) considers similarity between an article (digital content) and an advertisement that provides functions of embedding and attention-based similarity matcher between advertisement and content. The Interaction Scoring Module (ISM) considers market simulation and policy optimization and simulates bidding, allocation and scheduling across available ad slots. The Q-learning Agent learns the best matching and bidding strategy using RL rewards computer from LPM inputs.

The material disclosed herein may be implemented in software or firmware or a combination of them or as instructions stored on a machine-readable medium, which may be read and executed by one or more processors. A machine-readable medium may include any medium and/or mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others.

Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. In some embodiments, the one or more processors may be implemented as a Complex Instruction Set Computer (CISC) or Reduced Instruction Set Computer (RISC) processors; x86 instruction set compatible processors, multi-core, or any other microprocessor or central processing unit (CPU). In various implementations, the one or more processors may be dual-core processor(s), dual-core mobile processor(s), and so forth.

Computer-related systems, computer systems, and systems, as used herein, include any combination of hardware and software. Examples of software may include software components, programs, applications, operating system software, middleware, firmware, software modules, routines, subroutines, functions, methods, procedures, software interfaces, application program interfaces (API), instruction sets, computer code, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that make the logic or processor. Of note, various embodiments described herein may, of course, be implemented using any appropriate hardware and/or computing software languages (e.g., C++, Objective-C, Swift, Java, JavaScript, Python, Perl, QT, etc.).

In some embodiments, one or more of illustrative computer-based systems or platforms of the present disclosure may include or be incorporated, partially or entirely into at least one personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

As used herein, term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud servers are examples.

In some embodiments, as detailed herein, one or more of the computer-based systems of the present disclosure may obtain, manipulate, transfer, store, transform, generate, and/or output any digital object and/or data unit (e.g., from inside and/or outside of a particular application) that can be in any suitable form such as, without limitation, a file, a contact, a task, an email, a message, a map, an entire application (e.g., a calculator), data points, and other suitable data. In some embodiments, as detailed herein, one or more of the computer-based systems of the present disclosure may be implemented across one or more of various computer platforms such as, but not limited to: (1) FreeBSD, NetBSD, OpenBSD; (2) Linux; (3) Microsoft Windows™; (4) OpenVMS™; (5) OS X (MacOS™); (6) UNIX™; (7) Android; (8) iOS™; (9) Embedded Linux; (10) Tizen™; (11) WebOS™; (12) Adobe AIR™; (13) Binary Runtime Environment for Wireless (BREW™); (14) Cocoa™ (API); (15) Cocoa™ Touch; (16) Java™ Platforms; (17) JavaFX™; (18) QNX™; (19) Mono; (20) Google Blink; (21) Apple WebKit; (22) Mozilla Gecko™; (23) Mozilla XUL; (24) .NET Framework; (25) Silverlight™; (26) Open Web Platform; (27) Oracle Database; (28) Qt™; (29) SAP NetWeaver™; (30) Smartface™; (31) Vexi™; (32) Kubernetes™ and (33) Windows Runtime (WinRT™) or other suitable computer platforms or any combination thereof. In some embodiments, illustrative computer-based systems or platforms of the present disclosure may be configured to utilize hardwired circuitry that may be used in place of or in combination with software instructions to implement features consistent with principles of the disclosure. Thus, implementations consistent with principles of the disclosure are not limited to any specific combination of hardware circuitry and software. For example, various embodiments may be embodied in many different ways as a software component such as, without limitation, a stand-alone software package, a combination of software packages, or it may be a software package incorporated as a “tool” in a larger software product.

For example, exemplary software specifically programmed in accordance with one or more principles of the present disclosure may be downloadable from a network, for example, a website, as a stand-alone product or as an add-in package for installation in an existing software application. For example, exemplary software specifically programmed in accordance with one or more principles of the present disclosure may also be available as a client-server software application, or as a web-enabled software application. For example, exemplary software specifically programmed in accordance with one or more principles of the present disclosure may also be embodied as a software package installed on a hardware device.

In some embodiments, illustrative computer-based systems or platforms of the present disclosure may be configured to output to distinct, specifically programmed graphical user interface implementations of the present disclosure (e.g., a desktop, a web app., etc.). In various implementations of the present disclosure, a final output may be displayed on a displaying screen which may be, without limitation, a screen of a computer, a screen of a mobile device, or the like. In various implementations, the display may be a holographic display. In various implementations, the display may be a transparent surface that may receive a visual projection. Such projections may convey various forms of information, images, or objects. For example, such projections may be a visual overlay for a mobile augmented reality (MAR) application.

In some embodiments, illustrative computer-based systems or platforms of the present disclosure may be configured to be utilized in various applications which may include, but not limited to, gaming, mobile-device games, video chats, video conferences, live video streaming, video streaming and/or augmented reality applications, mobile-device messenger applications, and others similarly suitable computer-device applications.

As used herein, terms “cloud,” “Internet cloud,” “cloud computing,” “cloud architecture,” and similar terms correspond to at least one of the following: (1) a large number of computers connected through a real-time communication network (e.g., Internet); (2) providing the ability to run a program or application on many connected computers (e.g., physical machines, virtual machines (VMs)) at the same time; (3) network-based services, which appear to be provided by real server hardware, and are in fact served up by virtual hardware (e.g., virtual servers), simulated by software running on one or more real machines (e.g., allowing to be moved around and scaled up (or down) on the fly without affecting the end user).

In some embodiments, the illustrative computer-based systems or platforms of the present disclosure may be configured to securely store and/or transmit data by utilizing one or more of encryption techniques (e.g., private/public key pair, Triple Data Encryption Standard (3DES), block cipher algorithms (e.g., IDEA, RC2, RC5, CAST and Skipjack), cryptographic hash algorithms (e.g., MD5, RIPEMD-160, RTR0, SHA-1, SHA-2, Tiger (TTH), WHIRLPOOL, RNGs).

As used herein, the term “user” shall have a meaning of at least one user. In some embodiments, the terms “user”, “subscriber” “consumer” or “customer” should be understood to refer to a user of an application or applications as described herein and/or a consumer of data supplied by a data provider. By way of example, and not limitation, the terms “user” or “subscriber” can refer to a person who receives data provided by the data or service provider over the Internet in a browser session, or can refer to an automated software application which receives the data and stores or processes the data.

While various embodiments of the disclosure have been illustrated and described, it will be clear that the disclosure is not limited to these embodiments only. Numerous modifications, changes, variations, substitutions, and equivalents will be apparent to those skilled in the art, without departing from the spirit and scope of the disclosure, as described in the claims.

What is claimed is:

1. A method executed by one or more computing devices of a controller to generate a placement of a set of digital advertisements for digital content, wherein a processor is configured to:
receive, by the processor, a request to place the set of digital advertisements;
integrate, by the processor, a digital content valuation as an input to a reinforcement learning agent by vectorizing crawled digital content and digital content related to the digital advertisement into embeddings, and
determine a valuation of the digital content by considering one or more of historical performance of the digital content, audience behavior regarding the digital content, pricing of similar digital content, and external market indicators;
assign, by the processor, the criticality factor for the digital content valuation wherein the criticality factor is a score representing one or more of the following newsworthiness of the digital content, timeliness of the digital content, market competition level; demographic factors, macro economic factors and strategic priority;
employ, by the processor, the reinforcement learning agent to match advertisements with relevant content environments;
wherein the reinforcement learning agent predicts reward based on the digital content valuation and similarity of the embedding of the digital advertisement and the digital content to be advertised;
optimize, by the processor, the advertisement placement algorithm, wherein the optimization is provided by the digital content valuation;
generate, by the processor, a recommendation for advertisement placement by the advertisement placement algorithm, wherein generating the recommendation includes consideration of business constraints;
place, by the processor, the advertisement based on the recommendation; and
maximize, by the processor, engagement and revenue generation by updating the digital content valuation and reward valuation.

2. The system of claim 1, wherein the advertisement placement algorithm includes an allocation policy, wherein an action is performed based on the allocation policy.

3. The system of claim 2, wherein the processor is further configured to use the offline data of the advertisement to place the advertisement.

4. The system of claim 3, wherein the advertisement placement algorithm includes, an advertisement campaign.

5. The system of claim 4, wherein the offline data of the advertisement is used to generate advertisement campaign statistics.

6. The system of claim 5, wherein the matching advertisements with a relevant content environment includes a q-learning matching policy, wherein the q-learning matching policy perform the matching advertisements with a relevant content environment.

7. A method to generate recommendation to place a set of digital advertisements comprising:
receiving, by the processor, a request to place the set of digital advertisements;
integrating, by the processor, a digital content valuation as an input to a reinforcement learning agent by vectorizing crawled digital content and digital content related to the digital advertisement into embeddings, and
determining a valuation of the digital content by considering one or more of historical performance of the digital content, audience behavior regarding the digital content, pricing of similar digital content, and external market indicators;
assigning, by the processor, the criticality factor for the digital content valuation wherein the criticality factor is a score representing one or more of the following newsworthiness of the digital content, timeliness of the digital content, market competition level; demographic factors, macro economic factors and strategic priority;
employing, by the processor, the reinforcement learning agent to match advertisements with relevant content environments;
wherein the reinforcement learning agent predicts reward based on the digital content valuation and similarity of the embedding of the digital advertisement and the digital content to be advertised;
optimizing, by the processor, the advertisement placement algorithm, wherein the optimization is provided by the digital content valuation;
generating, by the processor, a recommendation for advertisement placement by the advertisement placement algorithm, wherein generating the recommendation includes consideration of business constraints;
placing, by the processor, the advertisement based on the recommendation; and
maximizing, by the processor, engagement and revenue generation by updating the digital content valuation and reward valuation.

8. The method of claim 7, wherein the advertisement placement algorithm includes an allocation policy, wherein an action is performed based on the allocation policy.

9. The method of claim 8, wherein the processor is further configured to use the offline data of the advertisement to place the advertisement.

10. The method of claim 9, wherein the advertisement placement algorithm includes an advertisement campaign.

11. The method of claim 10, wherein the offline data of the advertisement is used to generate advertisement campaign statistics.

12. The method of claim 11, wherein the matching advertisements with a relevant content environment includes a q-learning matching policy, wherein the q-learning matching policy perform the matching advertisements with a relevant content environment.

13. One or more non-transitory computer readable media having instructions stored thereon, the instructions executable by a processor to cause the processor to:
receive, by the processor, a request to place the set of digital advertisements;
integrate, by the processor, a digital content valuation as an input to a reinforcement learning agent by vectorizing crawled digital content and digital content related to the digital advertisement into embeddings, and determine a valuation of the digital content by considering one or more of historical performance of the digital content, audience behavior regarding the digital content, pricing of similar digital content, and external market indicators;
assign, by the processor, the criticality factor for the digital content valuation wherein the criticality factor is a score representing one or more of the following newsworthiness of the digital content, timeliness of the digital content, market competition level; demographic factors, macro economic factors and strategic priority;
employ, by the processor, the reinforcement learning agent to match advertisements with relevant content environments;
wherein the reinforcement learning agent predicts reward based on the digital content valuation and similarity of the embedding of the digital advertisement and the digital content to be advertised;
optimize, by the processor, the advertisement placement algorithm, wherein the optimization is provided by the digital content valuation;
generate, by the processor, a recommendation for advertisement placement by the advertisement placement algorithm, wherein generating the recommendation includes consideration of business constraints;
place, by the processor, the advertisement based on the recommendation; and
maximize, by the processor, engagement and revenue generation by updating the digital content valuation and reward valuation.

14. The non-transitory computer readable media of claim 13, wherein the advertisement placement algorithm includes an allocation policy, wherein an action is performed based on the allocation policy.

15. The non-transitory computer readable media of claim 14, wherein the processor is further configured to use the offline data of the advertisement to place the advertisement.

16. The non-transitory computer readable media of claim 15, wherein the advertisement placement algorithm includes, an advertisement campaign.

17. The non-transitory computer readable media of claim 16, wherein the offline data of the advertisement is used to generate advertisement campaign statistics.
